(19) United States
(12) Patent Application Publication
(10) Pub. No.: US 2018/0288255 A1
(43) Pub. Date: Oct. 4, 2018

(54) IMAGE FORMING APPARATUS

(71) Applicant: CANON KABUSHIKI KAISHA, Tokyo (JP)

(72) Inventors: Yoshitaka Zaitsu, Suntou-gun (JP); Kazushi Suzuki, Suntou-gun (JP); Hideki Ohta, Numazu-shi (JP); Tamotsu Kaneko, Mishima-shi (JP)

(21) Appl. No.: 15/914,880

(22) Filed: Mar. 7, 2018

(30) Foreign Application Priority Data
Mar. 31, 2017 (JP) 2017-070097
Feb. 1, 2018 (JP) 2018-016244

(51) Int. Cl. H04N 1/00; H04N 1/04; G06T 5/50

(52) U.S. Cl. CPC H04N 1/00578; H04N 1/00596; G06T 5/50; H04N 1/04; H04N 1/00612

(57) ABSTRACT

An image forming apparatus includes an image reading unit, an original conveyance unit, a reversing unit, an image forming unit, an image forming conveyance unit, and a control unit. The original conveyance unit conveys an original in a first direction toward the image reading unit, which reads an image of the original. The reversing unit conveys an original passing through the image reading unit in the first direction, or reversely conveys the original toward the image reading unit in a second direction. The image forming unit forms an image on a sheet. The image forming conveyance unit conveys, to the image forming unit, an original reversely conveyed by the reversing unit via the image reading unit. The control unit controls an operation for reading an image of the original by using the image reading unit and for overprinting the original with an image by using the image forming unit.

### BACKGROUND OF THE INVENTION

### Field of the Invention

The present disclosure relates to an electrophotographic-type image forming apparatus, such as a copier or a laser beam printer, for forming an image on a sheet, and particularly relates to an image forming apparatus having an image reading unit for reading an image of an original.

### Description of the Related Art

Among image forming apparatuses that form an image on a sheet, there has been discussed an image forming apparatus that can read an image of an original and perform overprinting on the original with a print image corresponding to the image of the original. Japanese Patent Application Laid-Open No. 2014-219471 discusses an image forming apparatus, in which an image reading unit reads image information of an original, and then the original is conveyed to an image forming unit while being reversed. It is therefore possible to perform overprinting with an image after reading of all the image information of the original, irrespective of the length of the original in a conveyance direction. In such an image forming apparatus, the position of the image for overprinting should precisely coincides with the position of the image of the original.

Meanwhile, Japanese Patent Application Laid-Open No. 2005-57813 discusses an image reading apparatus that can detect a posture of an original by detecting an edge portion of the original by using an image reading unit, and correct a posture in image information that has been read.

### SUMMARY OF THE INVENTION

In an example, an image forming apparatus capable of reading an image of an original and overprinting the original with an image, with high positional accuracy of overprinting, is provided.

According to an aspect of the present invention, an image forming apparatus includes an image reading unit configured to read an image of an original, an original conveyance unit configured to convey an original in a first direction toward the image reading unit, an original reversing unit provided downstream of the image reading unit in the first direction, and configured to convey an original passing through the image reading unit in the first direction, or reversely convey the original toward the image reading unit in a second direction opposite to the first direction, an image forming unit configured to form an image on a sheet, an image forming conveyance unit configured to convey, to the image forming unit, an original reversely conveyed by the original reversing unit via the image reading unit, and a control unit configured to control an operation for reading an image of the original by using the image reading unit and for overprinting the original with an image by using the image forming unit, wherein, using first image information and second image information, the control unit provides an instruction for executing at least one of change of a posture of the original and correction of a print image for overprinting the original, wherein the first image information includes information which is about an edge portion of the original and is acquired via the image reading unit when the original is conveyed in the first direction, and wherein the second image information includes at least information which is about a leading edge portion of the original after reverse and is acquired via the image reading unit when the original is conveyed in the second direction.

Further features of the present invention will become apparent from the following description of embodiments with reference to the attached drawings.

### BRIEF DESCRIPTION OF THE DRAWINGS

FIG. 1 is a main cross-sectional diagram of an image forming apparatus according to a first embodiment.

FIG. 2 is an enlarged diagram of a part of FIG. 1.

FIG. 3 is a diagram illustrating a structure of a conveyance sensor according to the first embodiment.

FIGS. 4A and 4B illustrate a method for detecting a posture of an original according to the first embodiment.

FIGS. 5A and 5B illustrate a structure of a duplex conveying roller and a method for correcting a posture of an original, respectively, according to a second embodiment.

FIG. 6 is a main cross-sectional diagram of an image forming apparatus according to a third embodiment.

FIG. 7 is an enlarged diagram of a part of FIG. 6.

FIG. 8 is a main cross-sectional diagram of an example of an image forming apparatus.

### DESCRIPTION OF THE EMBODIMENTS

Embodiments will be described in detail below with reference to the drawings. Dimensions, materials, and shapes of components described in the following embodiments, as well as relative arrangements of the components may be modified as appropriate depending on configurations and various conditions of an apparatus to which the present disclosure is applied, and are not to limit the scope.

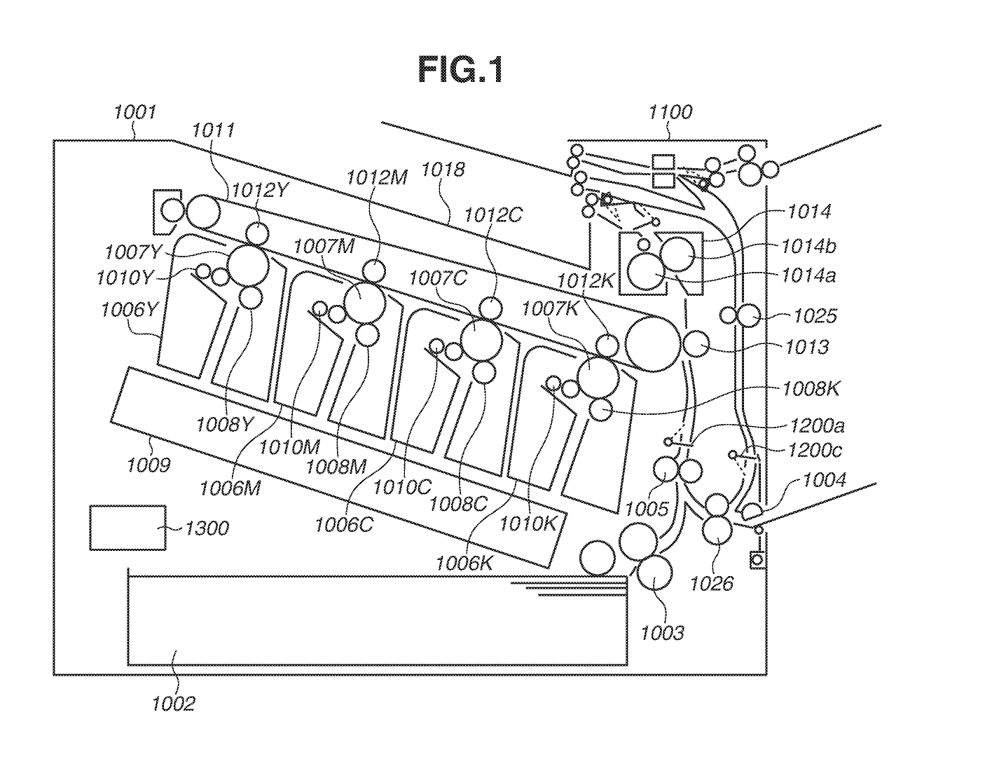

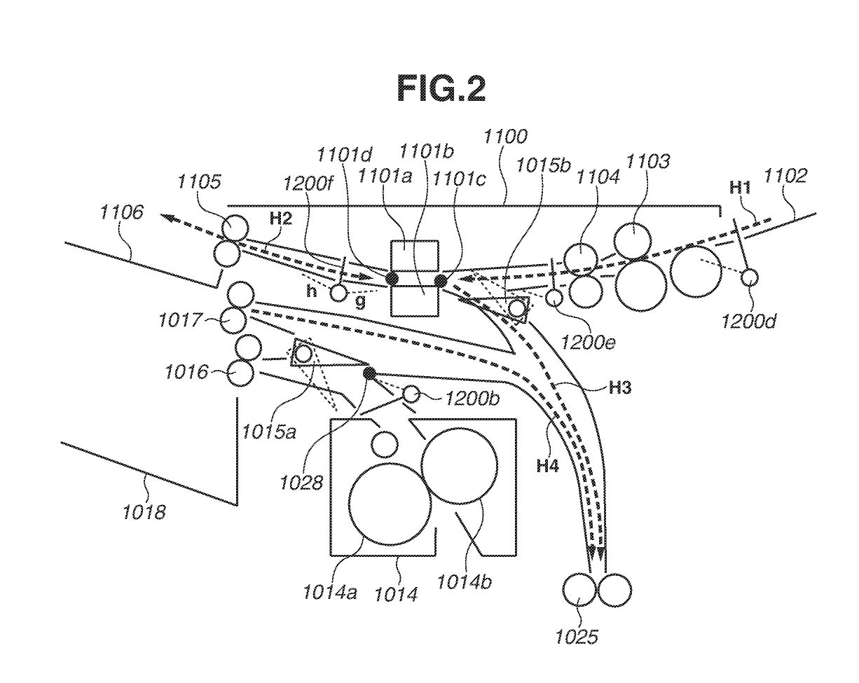

An image forming apparatus according to a first embodiment will be described with reference to FIGS. 1 and 2. FIG. 1 is a main cross-sectional diagram illustrating an overall configuration of an image forming apparatus 1001. FIG. 2 is a cross-sectional enlarged diagram of a part, which is near an image reading unit 1100, of the image forming apparatus 1001. In the present embodiment, a full color laser beam printer including a plurality of photosensitive drums is used as an example of the image forming apparatus, but the present disclosure is not limited to this example. The present disclosure is also applicable to, for example, a monochrome copier and a printer having a single photosensitive drum.

As illustrated in FIG. 1, a cassette 1002 for housing a recording material serving as a sheet for recording is mounted at a lower part of the image forming apparatus 1001. The cassette 1002 can be drawn out from the image forming apparatus 1001. A cassette feeding unit 1003 serving as a feeding unit for feeding the recording material is disposed near an end portion of the cassette 1002. Further, a manual feeding unit 1004, which serves as a feeding unit for feeding a recording material serving as a sheet for recording, is disposed on one side face of the image forming apparatus 1001. The cassette feeding unit 1003 and the manual feeding unit 1004 each feed recording materials one by one to a registration roller 1005, by separating the recording materials. A conveyance sensor 1200a for detecting passage of a recording material is disposed downstream of the registration roller 1005 in a conveyance direction of the recording material. When the conveyance sensor 1200a is pushed up by the recording material and located at a position indicated with a dotted line in FIG. 1, the conveyance sensor 1200a detects the recording material being correctly conveyed.

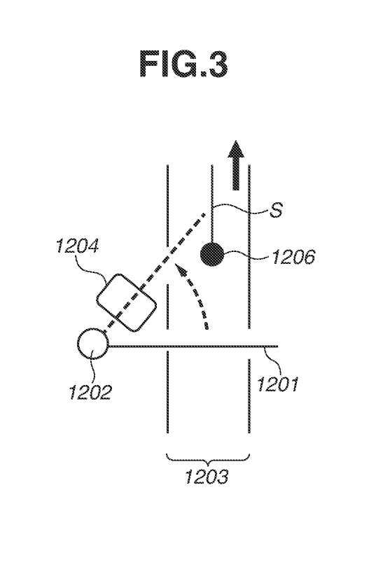

Here, the conveyance sensor 1200a will be described with reference to FIG. 3. FIG. 3 is a diagram illustrating a structure of the conveyance sensor 1200a. As illustrated in FIG. 3, the conveyance sensor 1200a includes a sensor arm 1201 and a detecting unit 1204. The sensor arm 1201 is disposed to protrude into a conveyance path 1203 and supported turnably about a shaft supporting unit 1202. The detecting unit 1204 detects movement of the sensor arm 1201. The sensor arm 1201 is maintained at a position indicated with a solid line in FIG. 3 by an urging member (not illustrated) such as a spring. When a recording material S moving in a solid-line arrow direction in FIG. 3 reaches the conveyance sensor 1200a, the sensor arm 1201 is pushed up by the recording material S and moves to a position indicated with a dashed line in FIG. 3. The detecting unit 1204 detects the movement of the sensor arm 1201, and transmits a signal for notifying that the recording material S has reached the conveyance sensor 1200a to a control unit (a control unit 1300 in FIG. 1). Subsequently, when the recording material S further moves and an upstream end 1206 of the recording material S in the conveyance direction leaves the sensor arm 1201, the sensor arm 1201 moves to the position indicated with the solid line in FIG. 3. Here, of the recording material S, an edge facing downstream is a leading edge, and an edge facing upstream is a rear edge, in the conveyance direction. The detecting unit 1204 detects the movement of the sensor arm 1201, and transmits a signal for notifying that the recording material S has passed the conveyance sensor 1200a to the control unit (the control unit 1300 in FIG. 1). For the conveyance sensor 1200a, a method other than the above-described method can be used. For example, a method for emitting light or an ultrasonic wave to a passing recording material and detecting a reflection wave may be used.

As illustrated in FIG. 1, the image forming apparatus 1001 has an image forming unit 1006 for forming an image on a recording material serving as a sheet for recording. The image forming unit 1006 includes image forming stations 1006Y, 1006M, 1006C, and 1006K corresponding to yellow, magenta, cyan, and black, respectively. The image forming unit 1006 further includes photosensitive drums 1007Y, 1007M, 1007C, and 1007K (hereinafter collectively referred to as the photosensitive drum 1007) that each serve as an image bearing member. The image forming unit 1006 further includes charging devices 1008Y, 1008M, 1008C, and 1008K that each charge a surface of the photosensitive drum 1007. The image forming unit 1006 further includes a scanner unit 1009 that forms an electrostatic latent image on the photosensitive drum 1007 by emitting a laser beam based on print image information held in the control unit 1300. The image forming unit 1006 further includes development devices 1010Y, 1010M, 1010C, and 1010K that each develop a toner image by adhering toner to the electrostatic latent image formed thereon. The image forming unit 1006 further includes primary transfer units 1012Y, 1012M, 1012C, and 1012K (hereinafter collectively referred to as the primary transfer unit 1012) that each transfer the toner image on the photosensitive drum 1007 to a transfer belt 1011. The toner image transferred to the transfer belt 1011 by the primary transfer unit 1012 is transferred to a recording material at a second transfer unit 1013. Here, the print image information held in the control unit 1300 is generated based on information received from a computer on a network or an external recording device directly connected to the image forming apparatus 1001, or held in the control unit 1300 beforehand.

Then, the recording material is conveyed to a fixing device 1014, and passes through a nip portion formed by a heating unit 1014a and a pressing roller 1014b in pressure contact with the heating unit 1014a, in the fixing device 1014. The toner image transferred to the recording material is subjected to a fixing process in the fixing device 1014. As illustrated in FIG. 2, a conveyance sensor 1200b is disposed downstream of the fixing device 1014. When the conveyance sensor 1200b is pushed up by the recording material and located at a position indicated with a dotted line in FIG. 2, the conveyance sensor 1200b detects the recording material being correctly conveyed.

After passing through the fixing device 1014, the sheet is guided to a discharge roller 1016 or a switchback roller 1017 disposed above the discharge roller 1016, by a duplex switching member 1015a. The discharge roller 1016 is a discharge unit that discharges a recording material having an image formed in the image forming unit 1006 toward a recording material stacking unit 1018. The switchback roller 1017 is a reversing unit for reversing a conveyance direction of a recording material having one surface where an image is formed in the image forming unit 1006. The duplex switching member 1015a is a switching unit switchable to guide a sheet having an image formed in the image forming unit 1006 to the discharge roller 1016 or the switchback roller 1017.

Here, when a recording material is discharged to the outside of the apparatus, as illustrated in FIG. 2, the duplex switching member 1015a is moved using a driving unit (not illustrated) to a position indicated with a solid line before the leading edge of the recording material passes through the fixing device 1014. A solenoid, a motor, or a spring can be used as the driving unit. Then, the recording material is conveyed from the fixing device 1014 to the discharge roller 1016, and then discharged to the recording material stacking unit 1018 by the discharge roller 1016. Here, a conveyance path can be formed to convey a recording material discharged by the discharge roller 1016 to a processing apparatus (not illustrated) disposed near the image forming apparatus 1001, so that post processes such as offsetting, binding, and sorting of recording materials can be performed.

When, as well as on the front surface (one surface) of a recording material, printing is performed on the back surface (the other surface) of the recording material, as illustrated in FIG. 2, the duplex switching member 1015a is moved to a position indicated with a dashed line before the leading edge of the recording material passes through the fixing device 1014, whereby the recording material is conveyed from the fixing device 1014 to the switchback roller 1017. Then, until the rear edge of the recording material passes a conveyance guide end portion 1028, the recording material is conveyed by rotation (rotating forward) of the switchback roller 1017 in a direction (downward in FIG. 2) for conveying the recording material to the outside of the apparatus. Subsequently, the duplex switching member 1015a is moved to the position indicated with the solid line, whereby a fourth conveyance path H4 is formed to guide the recording material from the switchback roller 1017 to a duplex conveying roller 1025. Then, the rotation of the switchback roller 1017 is once stopped and is started (rotation backward) in a direction for conveying the recording material toward the inside of the apparatus (upward in FIG. 2), whereby the recording material is conveyed from the switchback roller 1017 to the duplex conveying roller 1025. After that, the recording material is then conveyed using the duplex conveying roller 1025 to a duplex feeding roller 1026.

A conveyance sensor 1200c is disposed downstream of the duplex conveying roller 1025 as illustrated in FIG. 1. When the conveyance sensor 1200c is pushed down by the recording material and located at a position indicated with a dotted line in FIG. 1, the conveyance sensor 1200c detects the time of passage of the leading edge of the recording material. The control unit 1300 forms a toner image, which is to be transferred to the back surface of the recording material, on the transfer belt 1011 by using the image forming unit 1006. After a lapse of a predetermined time period following the passage of the leading edge of the recording material through the conveyance sensor 1200c, the duplex conveying roller 1025 and the duplex feeding roller 1026 are once stopped to hold the recording material in such a manner that the leading edge of the recording material is pinched by the duplex feeding roller 1026. The duplex conveying roller 1025 and the duplex feeding roller 1026 are then rotated in a direction for conveying the recording material to the registration roller 1005, at an appropriate timing. The appropriate timing is such a timing that the toner image on the transfer belt 1011 and the recording material can coincide with each other in terms of position in a conveyance direction, on the second transfer unit 1013. The recording material is then conveyed to the registration roller 1005, the second transfer unit 1013, and the fixing device 1014. Afterward, the recording material having the toner image transferred and fixed onto the back surface is conveyed to the discharge roller 1016, and discharged to the recording material stacking unit 1018.

About feeding and discharging of an original and image reading, a configuration and an operation will be described below. The image reading unit 1100 for reading an image of an original serving as a sheet for reading is disposed at an upper right portion of the image forming apparatus 1001. The image reading unit 1100 includes an original switching member 1015b capable of performing switching, and image reading units 1101a and 1101b (hereinafter collectively referred to as the image reading unit 1101). The image reading unit 1100 further includes an original sheet tray 1102 for holding stacked originals, an original feeding unit 1103 for feeding an original, and an original registration roller 1104 serving as an original conveyance unit for conveying an original in a first direction (a direction toward the image reading unit 1101). The image reading unit 1100 yet further includes an original discharge roller 1105 for discharging an original after image reading, and an original discharge tray 1106 for stacking originals after image reading. The original sheet tray 1102 is disposed above the manual feeding unit 1004 illustrated in FIG. 1, and the original discharge tray 1106 is disposed above the recording material stacking unit 1018. Therefore, an access direction when a user places an original and a recording material is the same as an access direction when the user removes a discharged original and a discharged recording material. Therefore, an easy to use arrangement for the user is provided.

When an image of an original is read, the original switching member 1015b is moved to a position indicated with a solid line in FIG. 2, whereby a first conveyance path H1 for conveying an original from the original registration roller 1104 to a first original insertion opening 1101c of the image reading unit 1101 is formed. The first original insertion opening 1101c is on a side close to the original feeding unit 1103. Afterward, the original feeding unit 1103 separates originals stacked in the original sheet tray 1102 one by one sequentially from the bottom, and then feeds the original to the original registration roller 1104.

The original is then conveyed using the original registration roller 1104 to the image reading unit 1101. The original after an image is read by the image reading unit 1101 is conveyed in the first direction by the original discharge roller 1105, and discharged to the original discharge tray 1106. Here, a conveyance path for connecting a second original insertion opening 1101d of the image reading unit 1101 with the original discharge roller 1105 is defined as a second conveyance path H2. The second original insertion opening 1101d is on a side close to the original discharge roller 1105. The original discharge roller 1105 is provided downstream of the image reading unit 1101 in the first direction. The original discharge roller 1105 is an original reversing unit that conveys an original passing through the image reading unit 1101 in the first direction, or reversely conveys the original toward the image reading unit 1101 in a second direction opposite to the first direction.

A conveyance sensor 1200f avoids disturbing the conveyance of an original. Specifically, the conveyance sensor 1200f is configured to be movable from a position indicated with a solid line in FIG. 2 to both of a position indicated with a dotted line g and a position indicated with a dotted line h on the other side. A method other than this method can be used for the conveyance sensor 1200f. For example, a sensor that employs a method for emitting light and an ultrasonic wave and detecting a reflection wave can be used.

In a case where feeding of the number of originals specified by the user is completed, or no original remains in the original sheet tray 1102, the original feeding unit 1103 and the original registration roller 1104 are stopped. A stack detecting sensor 1200d detects presence or absence of an original in the original sheet tray 1102.

The image reading unit 1101 is disposed inside the image forming apparatus 1001, and on a route of an original passing through the first conveyance path H1 and the second conveyance path H2. Specifically, the image reading units 1101a and 1101b are disposed in such a manner that the respective image-reading surfaces face each other. A sensor, such as a contact image sensor (CIS), can be used as the image reading unit 1101. Because two image reading units are disposed to face each other, an image printed on each of both sides of an original passing between the two image reading units can be simultaneously read. In a case where it is not necessary to simultaneously read an image printed on each of both sides of an original, the image reading unit may be provided for only one side of the original. The image reading unit 1101 starts a reading operation after a lapse of a predetermined time period following passage of the leading edge of an original through a conveyance sensor 1200e, and ends the reading operation after a lapse of a predetermined time period following the passage of the rear edge of the original through the conveyance sensor 1200e. An image read by the image reading unit 1101 is stored in a computer on a network as electronic information, or transmitted to the control unit 1300 in FIG. 1. The control unit 1300 converts the received image into print image information to be copied to a new recording material.

Next, a configuration and an operation for overprinting an original will be described below. The control unit 1300 controls an operation for reading an image of an original and overprinting the original with an image.

First, an original for overprinting is placed in the original sheet tray 1102. The original is placed in the original sheet tray 1102 in such a manner that a surface for overwriting faces up. A subsequent operation for conveying the original from the original sheet tray 1102 to the original discharge roller 1105 via the image reading unit 1101 is similar to the above-described operation for reading an image of an original. An image of the original read by the image reading unit 1101 in this process is transmitted to the control unit 1300 as electronic information. The control unit 1300 holds the received electronic information as first image information, and generates electronic information of an image for overprinting the original, based on the first image information. In other words, the control unit 1300 generates print image information. The print image information is generated using the image (the first image information) of the original before reverse. This is to prevent a decrease in productivity of overprinting. The reason for this is as follows.

It is conceivable that there may be a case where information necessary to generate a print image is present near the rear edge of an original after reverse. Therefore, it is necessary to read an image up to a rear edge position of the original. In a case where print image information is generated using an image of an original before reverse, generation of a print image and formation of a toner image of the print image by the image forming unit 1006 can be executed while the original is being reversed. In contrast, in a case where print image information is generated using an image of an original after reverse, the generation of the print image information begins after the whole image of the original is read. Therefore, a time period needed to form a toner image of a print image is relatively long, which leads to a decrease in productivity.

After the rear edge of the original passes through the first original insertion opening 1101c of the image reading unit 1101, the original switching member 1015b is moved to a position indicated with a dotted line in FIG. 2. This forms a third conveyance path H3 for conveying the original from the first original insertion opening 1101c to the duplex conveying roller 1025. After the rear edge of the original passes through the second original insertion opening 1101d of the image reading unit 1101, the original discharge roller 1105 is stopped once and then rotated in a direction for conveying the original in a rightward direction in FIG. 2. The original is thereby conveyed from the original discharge roller 1105 to the duplex conveying roller 1025 via the image reading unit 1101. The duplex conveying roller 1025 functions as an image forming conveyance unit for not only conveying a recording material having an image formed on one surface to the image forming unit 1006, but also conveying an original reversely conveyed by the original discharge roller 1105 in the second direction via the image reading unit 1101. The original reversely conveyed from the duplex conveying roller 1025 serving as the image forming conveyance unit is conveyed to the image forming unit 1006 without being further reversely conveyed. The length of an original conveyance direction can be thereby reduced to be less than that of the image forming apparatus discussed in Japanese Patent Application Laid-Open No. 2014-219471. Therefore, the productivity can be refined. The image reading unit 1101 starts the reading operation after elapse of a predetermined time period starting from when the leading edge of the original reversely conveyed in the second direction passes through the conveyance sensor 1200f. The image reading unit 1101 ends the reading operation after the original passes for a length needed to detect the posture of the original. Here, the length needed to detect the posture of the original corresponds to a part of image information, and this part includes at least the leading edge of the original after reverse.

The image read by the image reading unit 1101 is transmitted to the control unit 1300 as electronic information. The control unit 1300 holds the received electronic information as second image information. The control unit 1300 detects a posture change of the original by using the second image information together with the first image information held beforehand. The control unit 1300 thereby corrects the print image information in such a manner that the posture of the print image for overprinting the original matches with the posture of the original. Here, for the posture change of the original, the control unit 1300 acquires first posture information of the original from the first image information, and acquires second posture information of the original from the second image information. The control unit 1300 then corrects the posture of the print image (the print image information) for overprinting the original, by using the first posture information and the second posture information. The print image information is thus corrected using the posture information of the original before and after the original is reversed, for the following reason. When being reversed, the original is partially exposed to the outside of the apparatus. Therefore, the posture of the original easily changes by receiving an external force from an air current or an obstacle in the outside of the apparatus.

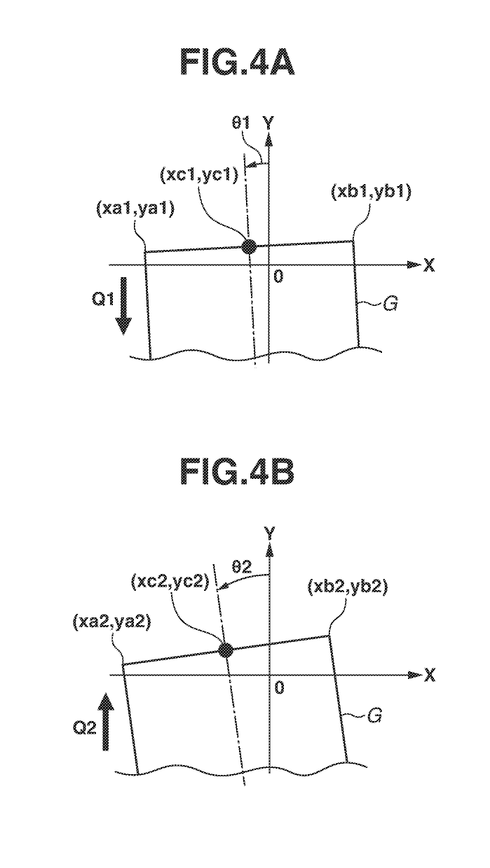

An example of each of the method for detecting the posture change of the original and the method for correcting the print image information will be described below. A common reference coordinate system is defined to express a posture of the original when each of the first image information and the second image information is read, i.e., an inclination and a central position of the original. First, as illustrated in FIGS. 4A and 4B, an X-axis and a Y-axis in the reference coordinate system are defined as follows. The Y-axis is an axis along the centerline of the second conveyance path H2 in which the direction (the second direction) from the original discharge roller 1105 toward the image reading unit 1101 on the second conveyance path H2 is normal. The X-axis is an axis orthogonal to the Y-axis. Further, as illustrated in FIG. 4A, the line segment of the rear edge (an upstream edge portion in a conveyance direction) of an original G when the first image information is read has the left endpoint and the right endpoint. The coordinates of the left endpoint and the coordinates of the right endpoint are (xa1, ya1) and (xb1, yb1), respectively. Here, the original G is conveyed in an arrow-Q1 direction (the first direction) in FIG. 4A.

An inclination θ1 of the original G with respect to the reference coordinate system is expressed by an expression (1).

e1=Arctan{(yb1−ya1)/(xb1−xa1)} (1)

Further, the center point of the line segment of the rear edge of the original G corresponds to coordinates (xc1, yc1), and these coordinates (xc1, yc1) are expressed by an expression (2) and an expression (3).

xc1=(xb1−xa1)/2 (2)

yc1=(yb1−ya1)/2 (3)

Further, as illustrated in FIG. 4B, the line segment of the leading edge (a downstream edge portion in a conveyance direction) of the original G when the second image information is read has the left endpoint and the right endpoint. The coordinates of the left endpoint and the coordinates of the right endpoint are (xa2, ya2) and (xb2, yb2), respectively. Here, the original G is conveyed in an arrow-Q2 direction (the second direction opposite to the first direction) in FIG. 4B.

An inclination θ2 of the original G with reference to the reference coordinate system is expressed by an expression (4).

θ2=Arctan{(yb2−ya2)/(xb2−xa2)} (4)

Further, the center point of the line segment of the leading edge of the original G corresponds to coordinates (xc2, yc2), and these coordinates (xc2, yc2) are expressed by an expression (5) and an expression (6).

xc2=(xb2−xa2)/2 (5)

yc2=(yb2−ya2)/2 (6)

Determined from the expressions (1) to (6) is a change in the posture of the original G when the second image information is read, with respect to the posture when the first image information is read. This change corresponds to a difference Δθ between the inclinations of the original G and a difference (Δx, Δy) between the central positions of the original G, and is expressed as follows.

Δθ=θ2−θ1 (7)

Δx=xc2−xc1 (8)

Δy=yc2−yc1 (9)

From the expressions (7) to (9), for example, the following method is performed to correct the print image information in such a manner that the posture of the print image matches with the posture of the original G when the second image information is read. Information of each pixel in the print image information is converted in such a manner that the print image is turned by Δθ with respect to the central position of the rear edge of the original when the first image information is read, and the print image is translated by (Δx, Δy) with respect to the reference coordinate system.

Here, the rear edge (the upstream edge portion in the first direction) of the original is used to obtain the posture information of the original before the original is reversed. However, an edge other than the rear edge of the original can also be used. Further, more accurate posture information of the original can also be obtained using the rear edge of the original and other edge together. Here, the posture information of the original before the original is reversed is the first posture information acquired from the first image information. The first image information includes the edge portion of the original and is acquired via the image reading unit when the original is conveyed in the first direction.

Further, the leading edge (the downstream edge portion in the second direction) of the original is used to obtain the posture information of the original after the original is reversed. However, a part of the left or right edge of the original near the leading edge of the original can also be used. Furthermore, more accurate posture information of the original can also be obtained using the leading edge of the original and the part of the left or right edge of the original together. Here, the posture information of the original after the original is reversed is the second posture information acquired from the second image information. The second image information includes at least the leading edge of the reversed original and is acquired via the image reading unit when the original is conveyed in the second direction.

The original of which the first image information and the second image information has been read is conveyed to the duplex conveying roller 1025. The original is then conveyed again to the registration roller 1005, in a procedure similar to the process for conveying the recording material by using the duplex conveying roller 1025 and thereafter, in the earlier-described printing for the back surface of the recording material. In this produce, the image forming unit 1006 forms a toner image on the primary transfer unit 1012, based on the corrected print image information which is for overprinting the original and held in the control unit 1300. The original is then conveyed to the second transfer unit 1013 and the fixing device 1014 in this order, and the toner image is transferred and fixed onto the surface for overprinting of the original. The original is then conveyed to the discharge roller 1016 and discharged to the recording material stacking unit 1018. In this way, the discharge roller 1016 serving as the discharge unit for discharging the recording material also serves as an original discharge unit for discharging the overprinted original.

In a case where overprinting is to be performed also on the back surface of the original, the original is conveyed to the registration roller 1005 again in a manner similar to the earlier-described printing for the back surface of the recording material.

As described above, according to the present embodiment, it is possible to improve the productivity further while maintaining the positional accuracy of the overprinting, in the image forming apparatus that reads an image of an original and performs overprinting on the original with an image corresponding to the image of the original.

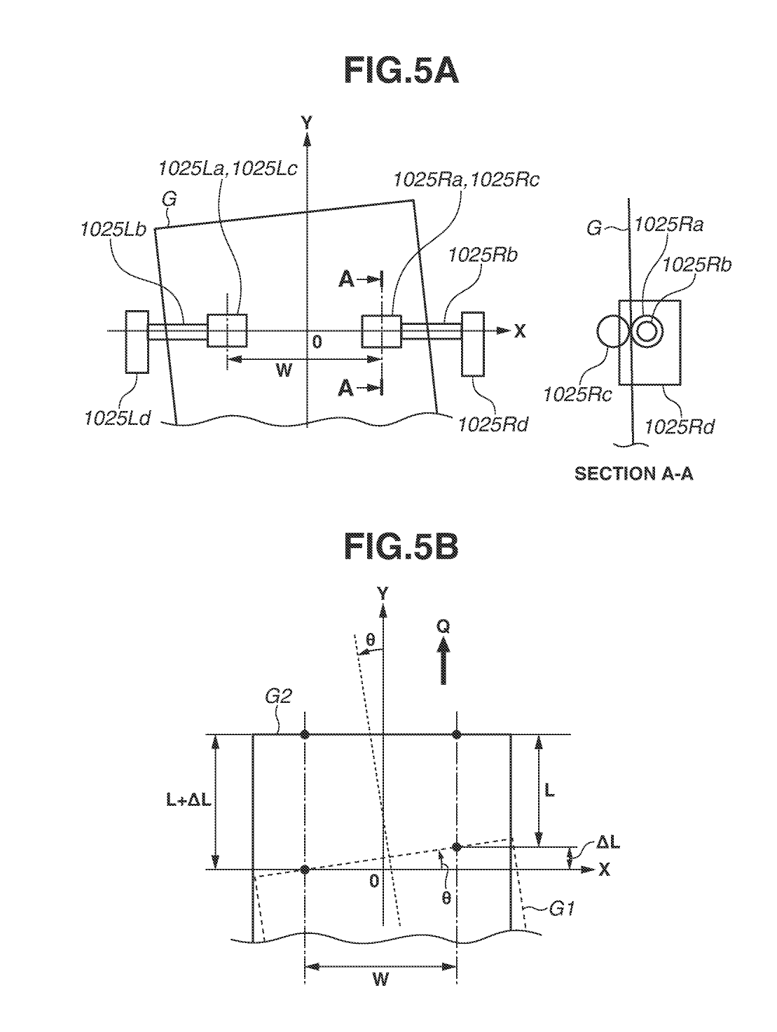

An image forming apparatus according to a second embodiment will be described with reference to FIGS. 5A and 5B. FIG. 5A is a diagram illustrating a structure of a duplex conveying roller, and FIG. 5B is a diagram illustrating a method for correcting a posture of an original by using the duplex conveying roller. The present embodiment is structurally different from the first embodiment only in that a duplex conveying roller 1025 has a function of changing the posture of the original. Therefore, here, a part of each of a structure of the duplex conveying roller 1025 and a process for overprinting an original will be described. Other parts are similar to those of the first embodiment and thus will not be described.

An example of a structure of the duplex conveying roller 1025 in the present embodiment will be described. As illustrated in FIG. 5A, the duplex conveying roller 1025 has such a structure that duplex conveying rollers 1025L and 1025R are arranged on the right and left of the centerline (a Y-axis in FIG. 5A) of a conveyance path. The duplex conveying rollers 1025L and 1025R are rotatable at the conveyance speeds independent of each other. The duplex conveying rollers 1025L and 1025R include driving rollers 1025La and 1025Ra, shafts 1025Lb and 1025Rb, following rollers 1025Lc and 1025Rc, and driving units 1025Ld and 1025Rd, respectively. The driving rollers 1025La and 1025Ra are fixed to the shafts 1025Lb and 1025Rb in such a manner that the distance between the respective centers is W. The shafts 1025Lb and 1025Rb have the respective central axes arranged in the same straight line, and are each restricted to have rotation flexibility only around the axis center. The following rollers 1025Lc and 1025Rc are disposed in such a manner that the respective positions in pressure contact with the driving rollers 1025La and 1025Ra to convey an original G while pinching the original G are located on the same plane parallel with the conveyance path. The shafts 1025Lb and 1025Rb are coupled to the drivers 1025Ld and 1025Rd, respectively, and the drivers 1025Ld and 1025Rd can thereby rotate the driving rollers 1025La and 1025Ra at the respective speeds independent of each other based on an instruction from the control unit 1300.

A method for changing the posture of the original by using the duplex conveying rollers 1025L and 1025R will be described below. As illustrated in FIG. 5B, assume that in a reference coordinate system, a Y-axis is the center of a conveyance path, and an X-axis is an axis orthogonal to the Y-axis and located on the conveyance path. Further, the normal direction of the Y-axis is the same as a conveyance direction (an arrow-Q direction in FIG. 5B). Assume that a posture (a posture corresponding to a position G1) of the original inclined an angle θ with respect the reference coordinate system is to be changed to a posture (a posture corresponding to a position G2) with an inclination 0 with respect to the reference coordinate system. To make this change, the following may be performed.

First, before a time T0 when the original is pinched by both of the duplex conveying rollers 1025L and 1025R, the duplex conveying rollers 1025L and 1025R are both rotated at a conveyance speed V. At the time T0, the original is located at the position G1 in FIG. 5B. Afterward, from the time T0 to a time (T0+ΔT), the duplex conveying rollers 1025L and 1025R are rotated at the conveyance speed V and a conveyance speed V+ΔV, respectively. At the time (T0+ΔT), the original is located at the position G2 in FIG. 5B. Assume that a distance for conveyance of the original by the duplex conveying roller 1025R is L, and a distance for conveyance of the original by the duplex conveying roller 1025L is (L+ΔL), from the time T0 to the time (T0+ΔT). In this case, L and ΔL are expressed by the following expressions (7) and (8), respectively.

L=VΔT (7)

ΔL=ΔVΔT (8)

Accordingly, a difference Δθ between the inclination of the original at the time T0 and that at the time (T0+ΔT) are expressed by the following expression (9).

Δθ=Arctan(ΔL/W) (9)

Therefore, to bring the original inclined the angle θ with respect to the reference coordinate system at the time T0 to the inclination 0 with respect to the reference coordinate system at the time (T+ΔT), ΔV may be determined by the following expression (10).

ΔV=WΔT{tan(−θ)} (10)

At the time (T0+ΔT) and thereafter, the duplex conveying rollers 1025L and 1025R are both rotated again at the conveyance speed V. Here, a time period for acceleration or deceleration needed to change the conveyance speed of each of the duplex conveying rollers 1025L and 1025R is ignored to simplify the description. In a case where the time period for acceleration or deceleration is considered, a speed change of each of the duplex conveying rollers 1025L and 1025R is time-integrated when ΔL of the expression is determined (8).

When overprinting of the original is to be performed, an inclination (posture) of the original is changed in a state where the original is pinched only by the duplex conveying roller 1025, after the original is reversed by the original discharge roller 1105. A value for changing the inclination of the original is defined as (θ1−θ2) in such a manner the inclination θ2 of the original after reverse matches with the inclination θ1 of the original before reverse. A change in the central position of the original leading edge is corrected by translating the position of each pixel of the print image information through use of a method similar to the correction of the print image described in the first embodiment.

The structure of the duplex conveying roller 1025 described here is an example, and not limitative. Other structure can be adopted if the structure has a function of changing the posture of the original. For example, the duplex conveying roller 1025 may have a structure to rotate together with the shaft, about an axis perpendicular to a conveyance path surface. Further, although the posture of the original is changed using the duplex conveying roller 1025 in the present embodiment, a new roller may be added as an original posture correction unit for changing the posture of the original.

According to the present embodiment, the posture of the original is corrected using the duplex conveying roller 1025 in a case where a posture change of the original after reverse is large. It is therefore possible to prevent damage to the original that may occur when the original is brought into contact with a wall surface of the conveyance path.

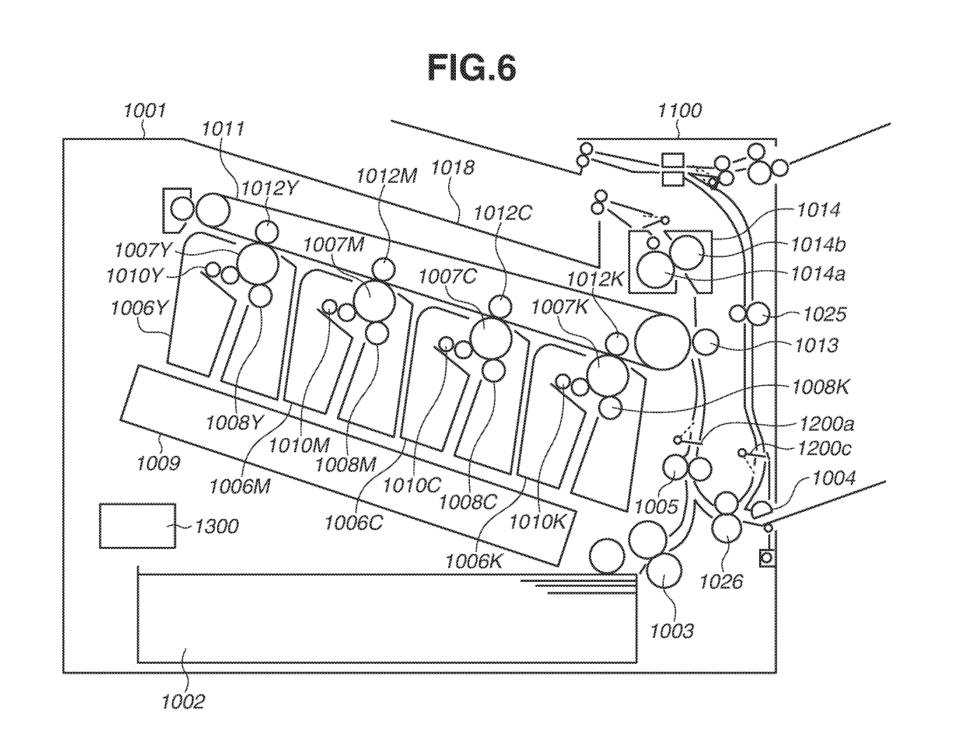

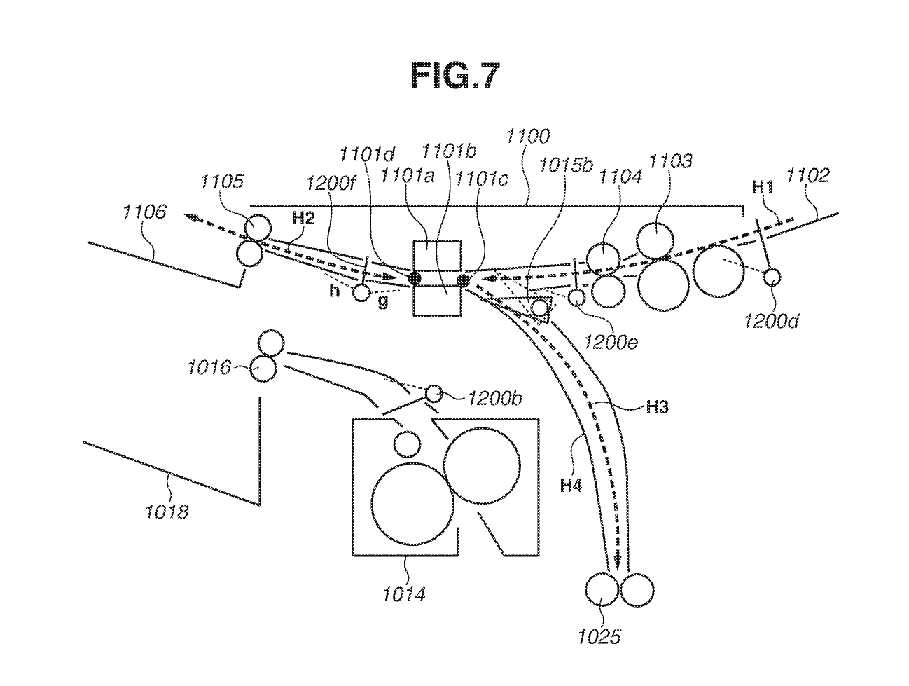

An image forming apparatus according to a third embodiment will be described with reference to FIGS. 6 and 7. FIG. 6 is a main cross-sectional diagram of an image forming apparatus 1001 according to the third embodiment. FIG. 7 is an enlarged diagram of a part, which is near an image reading unit 1100, of the image forming apparatus 1001. The present embodiment is structurally different from the first embodiment in that the duplex switching member 1015a, the switchback roller 1017, and the fourth conveyance path H4 in FIG. 2 are removed. This makes it possible to provide an image forming apparatus configured exclusively for one-sided printing and one-sided overprinting, with a simplified structure of low production cost.

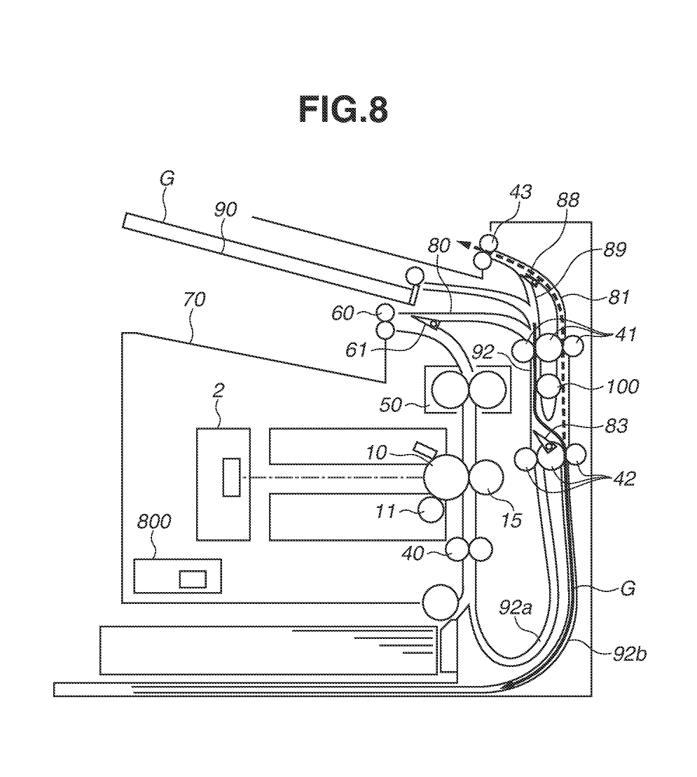

A configuration and an original overprinting operation of an example of an image forming apparatus will be described below with reference to FIG. 8. An original G having an image on one surface is placed in a document feeding unit 90 in such a manner that the surface where the image is formed faces upward in FIG. 8. The original G is then conveyed using a first duplex conveying roller 41 to an image reading unit 100 on a common conveyance path 92. The image reading unit 100 reads the image of the original G and transmits the read image to a control unit 800 as image information. Based on the image information of the original G, the control unit 800 generates print image information for overprinting the original G and posture information (first posture information) of the original G when the image is read. The original G is then conveyed using a second duplex conveying roller 42 to an original reversing conveyance path 92b. Subsequently, after the rear edge of the original G passes the tip of a flapper 83, the flapper 83 is changed to a position facing straight up in FIG. 8. The second duplex conveying roller 42 is then reversed to convey the original G to an original discharge conveyance path 81. Subsequently, the original G is conveyed using the first duplex conveying roller 41 to an original discharge roller 43. Further, after the rear edge of the original G passes the tip of a flapper 88, the flapper 88 is switched to turn in a clockwise direction in FIG. 8. The original discharge roller 43 is then reversed to convey the original G again to the image reading unit 100 on the common conveyance path 92. The image reading unit 100 reads an image near the leading edge of the original G, and transmits the read image to the control unit 800 as image information. Based on the image information of the image near the leading edge of the original G, the control unit 800 generates posture information (second posture information) of the original G after reverse. Further, using the first posture information and the second posture information of the original G, the control unit 800 detects a posture change of the original G before and after reverse to correct the print image information in a manner such that the posture of the original G corresponds to the posture of the original G after reverse. The original G is then conveyed to a U-turn unit 92a by using the second duplex conveying roller 42. Simultaneously, using an optical unit 2 and a development roller 11, a toner image corresponding to the print image information transmitted from the control unit 800 is formed on a photosensitive drum 10. The original G is then conveyed using a conveyance roller 40 to a transfer unit 15 and a fixing unit 50 in this order, and the toner image on the photosensitive drum 10 is transferred and fixed onto the original G. The original G is then discharged using a discharge roller 60 to a paper discharge unit 70.

In such an image forming apparatus, it is needed to perform an operation for reversing an original twice. This requires a time period for conveying the original over a distance almost double the length of the original in a conveyance direction. Accordingly, productivity of overprinting is less than that of the configuration described in the first embodiment.

In other words, according to the first embodiment, it is possible to improve the productivity further while maintaining the positional accuracy of the overprinting, in the image forming apparatus that reads an image of an original and performs overprinting on the original with an image corresponding to the image of the original.

In the above-described embodiments, the four image forming stations are used in the image forming unit, but the number of the stations is not limited to four, and may be set appropriately as needed.

Further, in the above-described embodiments, an electrophotographic method is used as an example of the recording method of the image forming unit, but this is not limitative. For example, other recording method such as an inkjet method may be adopted.

In the above-described embodiments, the operation of the control unit is specifically described. In summary, the control unit executes the following operation. The control unit acquires first image information including information about an edge portion of an original and acquired via the image reading unit when the original is conveyed in a first direction. Further, the control unit acquires second information including at least information about a leading edge portion of the original after reverse and acquired via the image reading unit when the original is conveyed in a second direction opposite to the first direction. Using the first image information and the second image information, the control unit provides an instruction for executing at least one of change of a posture of the original and correction of a print image for overprinting the original.

While the present invention has been described with reference to embodiments, it is to be understood that the invention is not limited to the disclosed embodiments. The scope of the following claims is to be accorded the broadest interpretation so as to encompass all such modifications and equivalent structures and functions.

This application claims the benefit of Japanese Patent Applications No. 2017-070097, filed Mar. 31, 2017, and No. 2018-016244, filed Feb. 1, 2018, which are hereby incorporated by reference herein in their entirety.

What is claimed is:

1. An image forming apparatus comprising:
an image reading unit configured to read an image of an original;
an original conveyance unit configured to convey an original in a first direction toward the image reading unit;
an original reversing unit provided downstream of the image reading unit in the first direction, and configured to convey an original passing through the image reading unit in the first direction, or reversely convey the original toward the image reading unit in a second direction opposite to the first direction;
an image forming unit configured to form an image on a sheet;
an image forming conveyance unit configured to convey, to the image forming unit, an original reversely conveyed by the original reversing unit via the image reading unit; and
a control unit configured to control an operation for reading an image of the original by using the image reading unit and for overprinting the original with an image by using the image forming unit,
wherein, using first image information and second image information, the control unit provides an instruction for executing at least one of change of a posture of the original and correction of a print image for overprinting the original,
wherein the first image information includes information which is about an edge portion of the original and is acquired via the image reading unit when the original is conveyed in the first direction, and
wherein the second image information includes at least information which is about a leading edge portion of the original after reverse and is acquired via the image reading unit when the original is conveyed in the second direction.

2. The image forming apparatus according to claim 1, wherein the control unit acquires first posture information of the original from the first image information and second posture information of the original from the second image information, and corrects the posture of the print image by using the first posture information and the second posture information.

3. The image forming apparatus according to claim 1, further comprising an original posture correction unit configured to change the posture of the original,
wherein the control unit corrects the posture of the original by using the original posture correction unit.

4. The image forming apparatus according to claim 1,
wherein the image forming conveyance unit has a function of changing the posture of the original, and
wherein the control unit corrects the posture of the original by using the image forming conveyance unit.

5. The image forming apparatus according to claim 1, further comprising:
a feeding unit configured to feed a sheet to the image forming unit; and
a discharge unit configured to discharge a sheet having an image formed by the image forming unit.

6. The image forming apparatus according to claim 5, wherein the discharge unit also serves as an original discharge unit configured to discharge an original on which overprinting is performed by the image forming unit.

7. The image forming apparatus according to claim 5, further comprising:
a reversing unit configured to reverse a conveyance direction of a sheet having an image formed on one surface by the image forming unit;
a switching unit configured to be switchable to guide the sheet having the image formed by the image forming unit to the discharge unit or to the reversing unit; and
a conveyance path provided to guide the sheet reversely conveyed by the reversing unit, to the image forming conveyance unit.

8. The image forming apparatus according to claim 1, wherein the image forming conveyance unit conveys the reversely conveyed original to the image forming unit without further reversely conveying the original.

9. A method for an image forming apparatus, the method comprising:
reading an image of an original via an image reading unit;
conveying, via a an original conveyance unit, an original in a first direction toward the image reading unit;
conveying, via an original reversing unit provided downstream of the image reading unit in the first direction, an original passing through the image reading unit in the first direction, or reversely convey the original toward the image reading unit in a second direction opposite to the first direction;
forming an image on a sheet via an image forming unit;
conveying, to the image forming unit via an image forming conveyance unit, an original reversely conveyed by the original reversing unit via the image reading unit; and
controlling an operation for reading an image of the original by using the image reading unit and for overprinting the original with an image by using the image forming unit,
wherein, using first image information and second image information, controlling includes providing an instruction for executing at least one of change of a posture of the original and correction of a print image for overprinting the original,
wherein the first image information includes information which is about an edge portion of the original and is acquired via the image reading unit when the original is conveyed in the first direction, and
wherein the second image information includes at least information which is about a leading edge portion of the original after reverse and is acquired via the image reading unit when the original is conveyed in the second direction.

10. A non-transitory computer-readable storage medium storing a program to cause an image forming apparatus to perform a method, the method comprising:
reading an image of an original via an image reading unit;
conveying, via a an original conveyance unit, an original in a first direction toward the image reading unit;
conveying, via an original reversing unit provided downstream of the image reading unit in the first direction, an original passing through the image reading unit in the first direction, or reversely convey the original toward the image reading unit in a second direction opposite to the first direction;
forming an image on a sheet via an image forming unit;
conveying, to the image forming unit via an image forming conveyance unit, an original reversely conveyed by the original reversing unit via the image reading unit; and
controlling an operation for reading an image of the original by using the image reading unit and for overprinting the original with an image by using the image forming unit,
wherein, using first image information and second image information, controlling includes providing an instruction for executing at least one of change of a posture of the original and correction of a print image for overprinting the original,
wherein the first image information includes information which is about an edge portion of the original and is acquired via the image reading unit when the original is conveyed in the first direction, and
wherein the second image information includes at least information which is about a leading edge portion of the original after reverse and is acquired via the image reading unit when the original is conveyed in the second direction.
